(19) United States
(12) Patent Application Publication
(10) Pub. No.: US 2005/0083431 A1
(43) Pub. Date: Apr. 21, 2005

(54) Image taking apparatus

(75) Inventor: Takuya Tsutsumi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Tokyo (JP)

(21) Appl. No.: 10/935,185

(22) Filed: Sep. 8, 2004

(30) Foreign Application Priority Data
Sep. 18, 2003 (JP) P2003-325664

(51) Int. Cl. H04N 5/225

(52) U.S. Cl. 348/360

(57) ABSTRACT

In an image taking apparatus having a mechanism for freely inserting/removing an IR cut filter on an optical axis of an image taking optical system of the image taking apparatus, the IR cut filter is made of one of film material and sheet material. Further the mechanism changes an image taking mode of the image taking apparatus between a first mode where the IR cut filter is located on the optical axis of the image taking optical system and a second mode, that is a low level light image taking mode where the IR cut filter is removed from the optical axis of the image taking optical system.

### BACKGROUND OF THE INVENTION

1. Field of the Invention

This invention relates to a technology where an insertion and removal mechanism of a filter (IR cut filter and the like) is realized with less component parts than a conventional technology, and when an image taking apparatus using this mechanism is applied to an image taking apparatus such as a video camera, a digital still camera, and the like, it becomes possible to perform downsizing and low cost of the image taking apparatus.

2. Description of the Related Art

An image taking apparatus having a mechanism capable of inserting an IR cut filter on an optical path of a lens system depending on a level of a luminance signal is well known, wherein such mechanism is able to selectively change between a low level light image taking mode (hereinafter referred to as a night shot function) and a normal image taking mode.

For example, in case of an apparatus provide with such mechanism that selectively inserts or removes an IR (Infra-red) cut filter and a dummy glass between lens groups and a solid state imaging device (such as disclosed in Patent Document 1), only the dummy glass is positioned on the optical path by insertion at the low level light image taking mode where an object and a periphery of the object are dark, and on the contrary, only the IR cut filter is positioned on the optical path by insertion at the normal image taking mode where the object and the periphery thereof are light.

As to a drive mechanism of the optical parts relating to the night shot function, following configurations are considered, for example.
A configuration where the dummy glass and the IR cut filter are rotated by a drive source, a gear and the like.
Another configuration where the dummy glass and the IR cut filter are linearly moved by a drive source, a gear and the like (such as disclosed in Patent Document 2).

FIG. 9 is a schematic exploded perspective view in a configuration of a main part of a conventional image taking apparatus, and shows one example a of a lens tube having an image taking optical system of 4-lens-group and inner focus type.

In this example, there are provided with a first lens group assembly G1, a second lens group assembly G2, a third lens group assembly G3, a forth lens group assembly G4, and a rear unit U5, and as shown in an enlarged view in FIG. 9, the rear unit U5 includes a mechanical unit for driving to freely insert or remove the IR cut filter b to or from an optical path (in this case, an imaging device (CCD type image sensor and the like, for example) is attached to the rear unit U5, although not shown).

In the rear unit U5, the IR cut filter b is inserted on the optical path under a normal image taking condition, but is removed from the optical path and is kept at an escaped position under a low level light image taking condition. In this case, the IR cut filter b is supported on its periphery by a support frame c, and the support frame c is driven integrally with the IR cut filter b by a drive mechanism d.

That is, a guide axis e is provided for guiding the support frame c when the support frame c is moved, and it is so configured to move the support frame c by transferring a drive force from an actuator f to the support frame c via a link mechanism (not shown). In this case, a rear frame g1 of the lens tube functions to support each of the component parts of the rear unit U5. Further, the mechanical unit is covered with a gear cover g2.

FIG. 10 schematically shows one example of the above mentioned link mechanism for driving the support frame c, wherein a drive force transfer mechanism using gears h1 to h3 is employed.

The gear h1 is rotated by an output axis (not shown) of the actuator f, and is geared with a gear having a small diameter included in the gear h2. Further, a gear having a large diameter included in the gear h2 is geared with the gear h3, and a part of the gear h3 is engaged with the support frame c. That is, the rotation power obtained from the output axis of a drive motor is sequentially transferred to the gear h1, the gear h2, and the gear h3. The rotation power of the gear h3 at the final stage is changed its direction by a cam surface of the support frame c (a crank arm integrated to the gear h3 is engaged with an elongated hole formed at the support frame c, and the rotation of the crank arm is transferred to an inner surface of the elongated hole), and thereby, the rotation power becomes a power to move the support frame c in parallel and along with the insertion and removal directions with respect to the optical path as shown by an arrow A in FIG. 10.

In this case, if glass material is used as the IR cut filter b, an image focus location is changed when the image taking mode is changed due to its thickness by the above mentioned insertion and removal of the IR cut filter b. As measures thereof, following methods have been known, for example.

(a) A method where a dummy glass is inserted (such as disclosed in Patent Document 2).

(b) A method where an image focus location adjusting member (such as a spacer) is inserted between a lens tube and a mount ring in order to fix a flange back by widening a distance between a flange surface and a final refractive surface of lens (such as disclosed in Patent Document 3).

(c) A method for responding by a control processing such as adding a focus lens position correction value to a tracking curve data (such as disclosed in Patent Document 4).
Patent Document 1: Japanese Laid-Open Patent JP7-107355
Patent Document 2: Japanese Laid-Open Patent JP2003-161981
Patent Document 3: Japanese Laid-Open Patent JP2002-98876
Patent Document 4: Japanese Laid-Open Patent JP 11-72691.

However, according to the conventional configuration, there are problems in a structure of the insertion and removal mechanism for the IR cut filter, in the number of parts, and in its cost.

For example, in a mechanism for rotating or moving a glass type IR cut filter, a lot of parts such as decelerator and the like are required, and this causes a factor for preventing downsizing of an image taking apparatus. Further when compared with an image taking apparatus not having the above mentioned night shot function, this causes a high cost, and also causes extreme disadvantages in an aspect of assembly process.

Further regarding problem that an image focus location is changed due to the thickness of the IR cut filter when the filter is inserted/removed, it becomes necessary to prepare additional parts such as a dummy glass and spacer in case of the above mentioned methods (a), and (b). This also becomes reasons for preventing downsizing and cost down of an image taking apparatus. Further in case of the above mentioned method (c), it is necessary to increase a move amount of a focus lens corresponding to the correction, and accordingly this prevents downsizing of a lens tube, and also a decrease of an optical performance cannot be avoided.

### SUMMARY OF THE INVENTION

Accordingly, problems to be solved by the invention are downsizing, reduction of the number of parts, and cost of an image taking apparatus having an insertion and removal mechanism for an IR cut filter, and the like.

In the present invention in order to solve the above mentioned problems, there is proposed a mechanism which is able to locate a filter made of film material or sheet material by freely inserting/removing on an optical axis of an image taking optical system.

Thereby, it is able to form a thin and light-weight filter using film material or sheet material according to the present invention.

According to the present invention, in place of a conventional glass filter, a filter is fabricated with film material or sheet material, and therefore, it is able to simplify an insertion and removal mechanism for the filter, and to reduce the number of parts and cost. Further, it is able to relax an affection to an optical performance caused by insertion/removal of the filter without using any adjusting member such as dummy filter and spacer.

Further in an embodiment having an IR cut filter as the filter, it is able to easily carry out a filter change by insertion/removal depending on the brightness of an object by providing a mechanism for changing image taking modes between a first mode where the filter is inserted or located on an optical axis of the image taking optical system and a second mode, that is a low level light image taking mode where the filter is removed from or not located on the optical axis of the image taking optical system.

When a configuration where the filter is driven directly by an arm, a lever and the like without using a support frame for the filter is employed, and accordingly, the present invention is suitable for weight saving and downsizing, and its mechanism becomes simple, because the filter is driven without using a decelerator or the like.

Further, if the IR cut filter is formed by applying a coating for cutting IR ray to film material or sheet material, the fabrication of the filter becomes simple, and the freedom for the mechanical design is increased.

Further, in an adaptation to an imaging system having an inner focus type configuration, it becomes not necessary to use the above mentioned methods (a) to (c), and this invention is effective in downsizing of a lens tube and in preventing deterioration of an optical performance.

### BRIEF DESCRIPTION OF THE DRAWINGS

FIGS. 1A and 1B are schematic views for describing a basic configuration of an image taking apparatus according to the present invention;

FIG. 2 is a perspective view of an outward appearance of a lens tube according to the present invention;

FIG. 3 is an exploded perspective view of the lens tube shown in FIG. 2;

FIG. 4 is a perspective view and an exploded perspective view observed from an imaging surface side in a configuration example of a night shot mechanism of the present invention;

FIG. 5 is a perspective view and an exploded perspective view observed from an object side in the configuration example of the night shot mechanism of the present invention;

FIGS. 6A and 6B are schematic diagrams showing an internal configuration regarding the operation of the night shot mechanism of the present invention;

FIGS. 7A and 7B are diagrams for describing the IR cut filter of the present invention in comparison with the conventional glass filter;

FIGS. 8A and 8B are diagrams for describing a filter drive mechanism without any support frame of the present invention in comparison with a conventional filter drive mechanism having a support frame;

FIG. 9 is a diagram for showing a conventional lens tube; and

FIG. 10 a explanation view of one embodiment of the conventional filter drive mechanism provided at a rear unit.

### DESCRIPTION OF THE PREFERRED EMBODIMENTS

This invention is to propose an image taking apparatus having a mechanism for freely inserting/removing a filter between a lens or lens group and an imaging surface, and any affection to optical performances caused by a simplification of the mechanism and the insertion/removal of the filter is relaxed.

In place of a conventional glass IR cut filter, film materials or sheet materials are used to form an IR cut filter, and the IR cut filter is directly driven without using any decelerator, and a support frame. Thereby, it is able to perform downsizing of an optical system and the filter drive mechanism, reduction of the number of parts, and elimination of influence of the insertion/removal of the filter to the image focus location by using such thin IR cut filter. Accordingly, an image taking apparatus having a night shot mechanism is realized with a fully guaranteed optical performance.

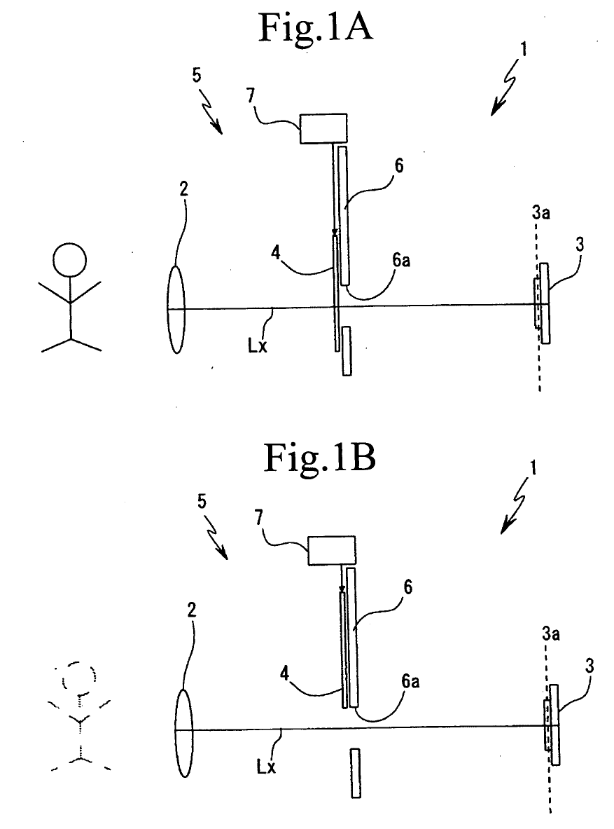

FIGS. 1A and 1B are schematic diagram for describing a basic configuration of an image taking apparatus according to the present invention.

A lens tube configuring the image taking apparatus 1 is provided with a lens or lens group 2 (the embodiment in the figure is shown with a single lens for simplifying the explanation), and image taking means 3 such as a solid state imaging device, and further a mechanism for locating a filter 4 between the lens and the imaging surface by freely inserting/removing the filter 4. As the image taking apparatus 1, in this case, adaptation to a video camera, a digital still camera, or a camera having functions of both moving image taking and still image taking is possible.

The filter 4 is made of film material, and in case of an IR cut filter, for example, a filter made by applying an IR cut coating on a thin film material is used. Adaptation of the present invention is not limited to the IR cut filter, and the present invention is able to adapt to a configuration example employing a filter for cutting or transmitting an ultra violet ray or a visible light.

FIG. 1A shows a state where the filter 4 is located on the optical axis Lx to cover an opening 6a formed on a support member 6.

A drive mechanism 7 for the filter 4 is provided for rotating or linearly moving the filter 4, and is designed without using any support frame to directly drive the filter 4 by an arm or the like, to drive the filter 4 with a magnetic force by attaching a magnet or the like thereto, and to drive with a electrostatic force.

FIG. 1B shows a state where the filter 4 is located apart from the optical axis Lx, and the opening 6a formed at the support member 6 is opened. That is, the filter 4 is rotated or moved by the drive mechanism 7, and is escaped to a position where any optical affection does not occur to an image taking optical system including a lens, the lens group 2, and the imaging device 3. In this case, the filter 4 is formed with thin material, therefore, a dummy filter or the like to be provided in consideration that the change of the length of the optical path by the insertion/removal of the filter affects to an imaging performance is not necessary.

As shown in FIG. 1A, the filter 4 is in the first state where it is located on the optical axis Lx of the image taking optical system, and as shown in FIG. 1B, the filter 4 is in the second state where it is not located on the optical axis Lx of the image taking optical system. In this case, the change mechanism of the filter location is carried out by the operation of the drive mechanism 7 in response to a comparison result obtained by comparing a level of an image signal (luminance signal) from the imaging device 3 and a previously determined threshold value.

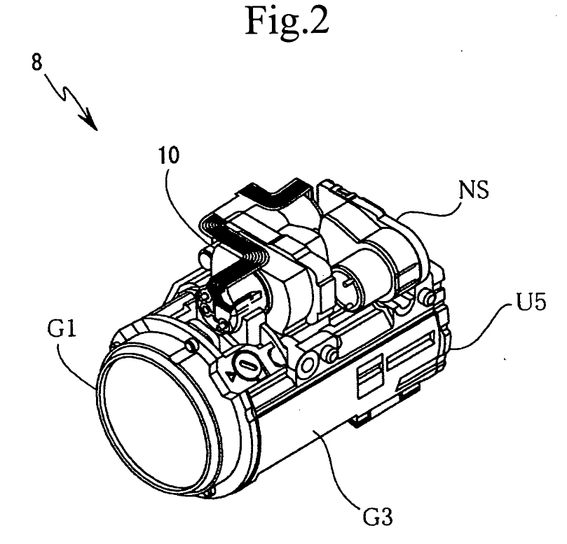

FIG. 2 to FIGS. 6A and 6B show one example of a lens tube 8 having the night shot function.

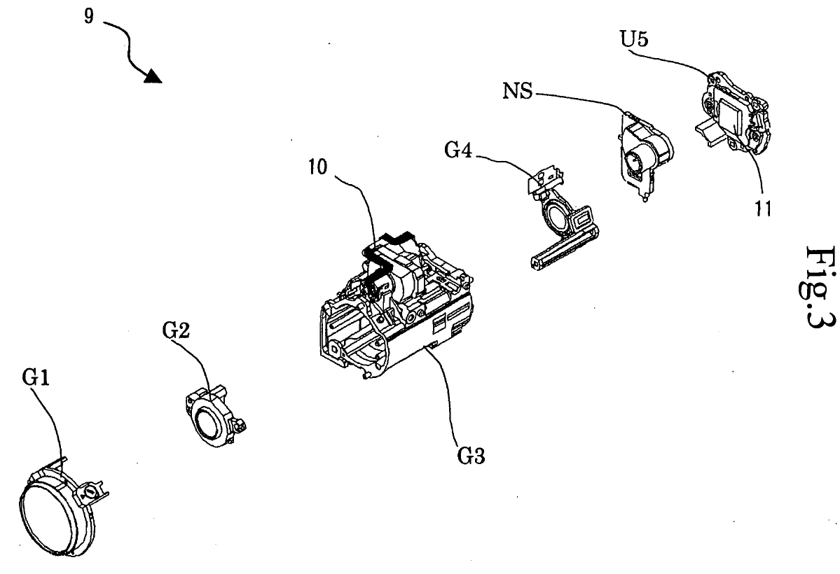

FIG. 2 is a perspective view showing the lens tube 8 as a whole, and FIG. 3 shows an exploded perspective view thereof.

In this embodiment, an image taking optical system 9 has a configuration of a 4-lens-groups and inner focus type including a first lens group assembly G1, a second lens group assembly G2, a third lens group assembly G3, a forth lens group assembly G4, a night shot mechanism NS, and a rear unit U5. In this case, the first lens group assembly G1 includes a lens and a support frame for the lens, and the third lens group assembly G3 includes an iris drive unit 10. In addition, each of the second lens group assembly G2 and the forth lens group assembly G4 includes a moving lens and its moving frame, and the rear unit U5 includes a solid state imaging device 11 having a sensitivity in a visible light range and an IR ray range.

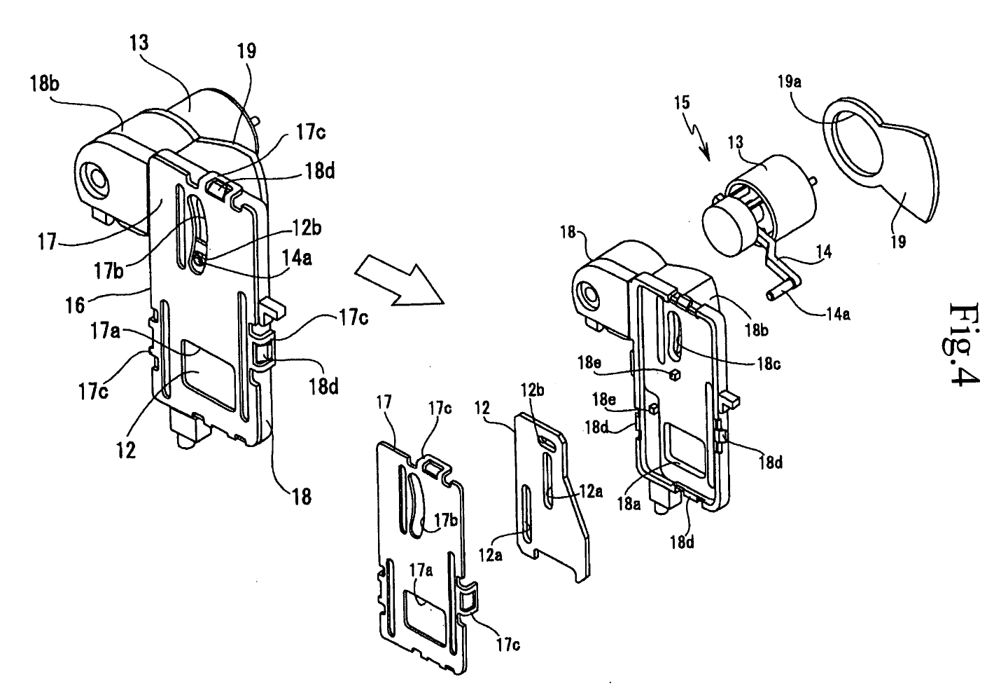

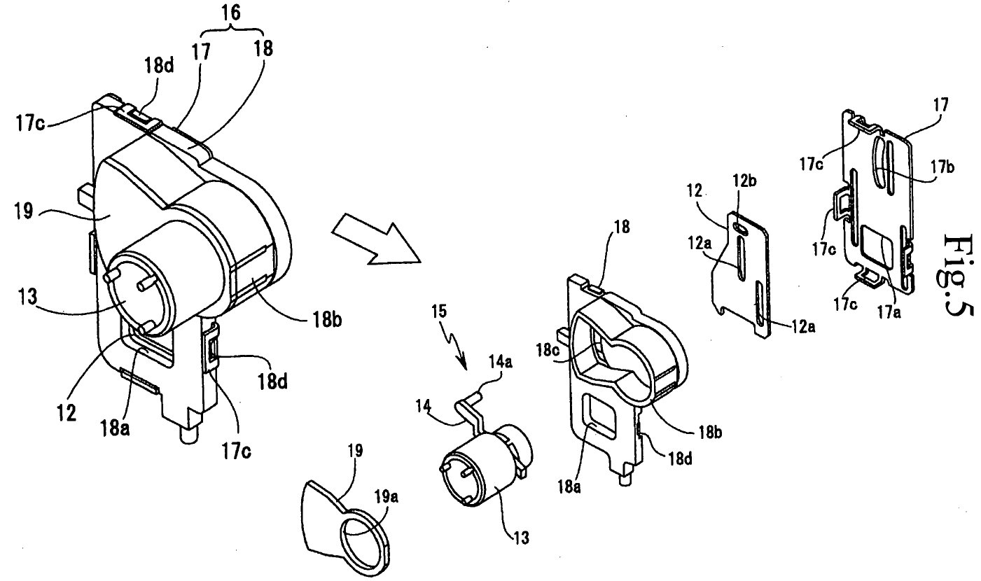

FIG. 4 and FIG. 5 show one exemplified embodiment of the night shot mechanism NS of the present invention, wherein FIG. 4 is a perspective view and an exploded perspective view observed from an imaging surface side, and FIG. 5 is a perspective view and an exploded perspective view observed from an object side, respectively.

In the present embodiment, the IR cut filter 12 (having a function of cutting off light components having a wavelength range of an infra-red ray) formed by thin sheet material is used, and is configured to insert/remove the filter relative to an optical path in upward or downward direction by a drive means 15 including an actuator 13 and an arm 14.

As shown in the figure, a main body unit 16 of the night shot mechanism NS includes a plate member 17 formed with a metal plate and the like, and a base member 18 for housing the drive means 15.

In the IR cut filter 12, elongated guiding apertures 12a, 12a extending in the moving direction are formed in parallel to each other, and at near one of them, there is formed an elongated engaging aperture 12b extending in a direction orthogonal to the moving direction of the IR cut filter 12.

In the plate member 17, a rectangular aperture 17a corresponding to the above mentioned opening 6a is formed, and at a position apart a bit from this, an arc-shaped elongated aperture 17b is formed approximately along with a moving direction (up and down directions) of the IR cut filter 12. In this case, on periphery of the plate member 17, a plurality of elongated portions 17c, 17c . . . is provided in engagement with a base member 18.

The base member 18 is formed with synthetic resin material or the like, and a rectangular aperture 18a is formed at a position corresponding to the rectangular aperture 17a and with the same shape. In addition, a peripheral wall portion 18b configuring a housing unit of the drive means 15 is formed, and at a portion surrounded by the peripheral wall portion 18b, an elongated aperture 18c is formed at a position corresponding to the above mentioned elongated aperture 17b.

In this case, at the base member 18, engaging pawls 18d, 18d . . . corresponding to each of the engaging portions 17c of the plate member 17 are formed, and the IR cut filter 12 is housed in a space formed between the base member 18 and the plate member 17 while they are linking to each other. In addition, each of the guide portions 18e, 18e (shown in FIG. 4) integrally formed with the base member 18 is inserted into each of the elongated apertures 12a, 12a of the IR cut filter 12, and the IR cut filter 12 is supported in a movable condition along with an extending direction of the elongated aperture 12a.

The actuator 13 rotated by the arm 14 is a crank shaped, and an engaging axis (operation edge) 14a projected from its tip is engaged with an elongated engaging aperture 12b of the filter 12 and with the elongated aperture 17b of the plate member 17 through the elongated aperture 18c in a penetrated condition, respectively.

The arm 14 and the actuator 13 are assembled within a peripheral wall portion 18b, then covered with a cover 19, but a portion of the actuator 13 is exposed to the outside through a circular aperture 19a of the cover 19.

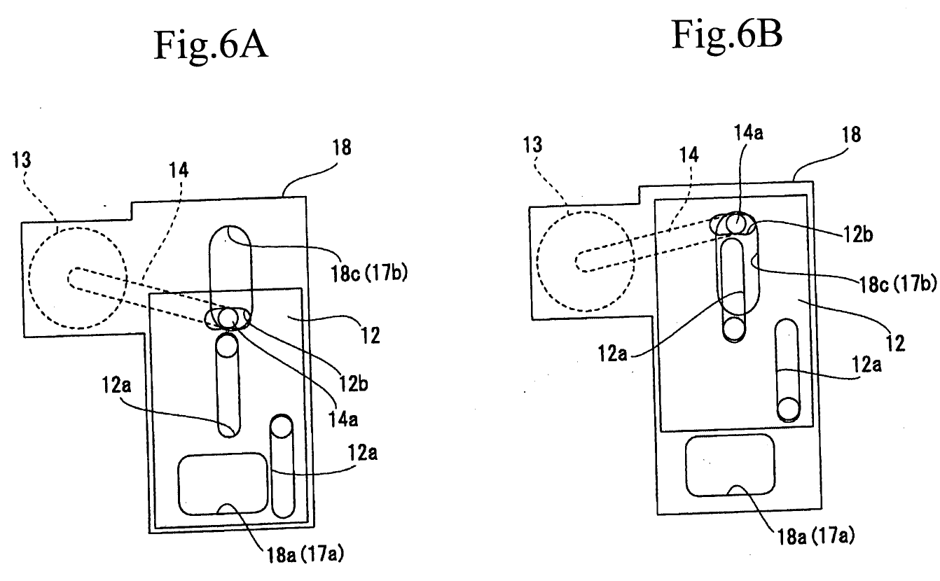

FIGS. 6A and 6B schematically show internal configuration of the night shot mechanism NS, wherein FIG. 6A is the state in the normal image taking mode, and FIG. 6B is the state in the low level light image taking mode. In this case, a circle depicted within respective elongated aperture 12a of the IR cut filter 12 is a guide supporting unit (refer to guide portions 18e in FIG. 4).

First, as shown in FIG. 6A, when the object and the periphery thereof are bright, the IR cut filter 12 is located downward in the figure, and a part of the IR cut filter 12 covers all of the opening (rectangular aperture 17a, 18a). Accordingly, IR rays of the light incident on the solid state imaging device 11 through the lens group from the object are cut.

Further, in the low level light image taking mode, the arm 14 rotates in a counter-clockwise direction by the actuator 13 as shown in FIG. 6B. Thereby, the engaging axis 14a of the arm 14 lifts up the IR cut filter 12 upward in the figure, and the IR cut filter 12 is held at a position apart from the above mentioned opening (that is, the rectangular aperture 17a, 18a). Accordingly, components including the IR ray of the light passing through the lens group from the object incident on the solid state imaging device 11.

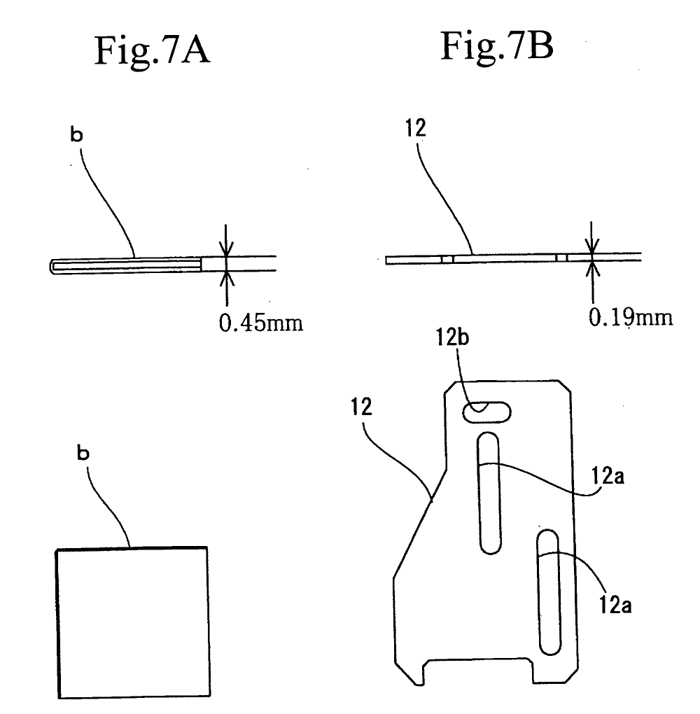

FIGS. 7A and 7B are diagrams where the IR cut filter 12 is shown in contrast with a conventional glass filter b.

The conventional filter b shown in FIG. 7A has a rectangular shape, and the thickness thereof is 0.45 mm, while the thickness of the IR cut filter 12 shown in FIG. 7B is 0.19 mm, and it has greater freedom in designing its shape.

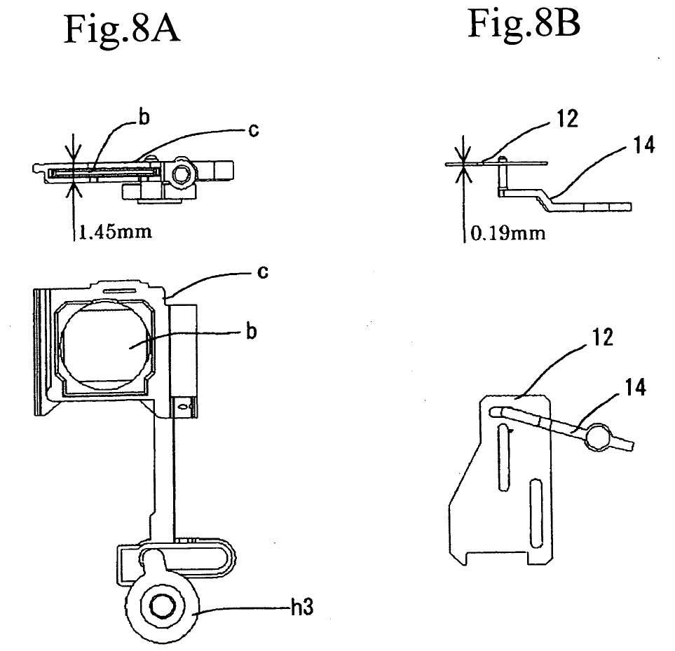

FIGS. 8A and 8B are diagrams where the drive mechanism using the IR cut filter 12 is shown in contrast with a conventional drive mechanism using the glass filter b.

In a conventional configuration as shown in FIG. 8A, a thickness of the support frame c for supporting the filter b is 1.45 mm, while in the configuration as shown in FIG. 8B according to the present invention, no support frame is required and accordingly, it only requires 0.19 mm in thickness that is the thickness of the filter 12. Further in this mechanism, it is not required to use a complex mechanism for driving filters like conventional example, and the IR cut filter 12 can be directly driven by the arm 14.

According to the above described construction, following advantages are expected.

That is, by using this thin IR cut filter 12, it is able to shorten a total length of the optical path, and attain downsizing of the lens tube. For example, there is provided a margin of 0.45-0.19=0.26 mm by using sheet material instead of glass material in the example in FIG. 7B, and accordingly, a freedom in an optical design is improved. Thereby, it becomes possible to perform downsizing and high performance.

As the IR cut filter is processed by using thin material such as sheet material, a filter changing operation is carried out by directly driving the IR cut filter without any support frame. Further, as the IR cut filter of the present invention is light in weight compared to a conventional glass IR cut filter, it becomes possible to carry out the filter changing operation without using any decelerator or the like, and is suitable for reducing the number of parts, and for downsizing. For example, there is provided a margin of 1.45-0.19=1.26 mm between the final refractive surface of lens and the image focus location in the example in FIG. 8B, and accordingly, a freedom in an optical design is improved. Thereby, it becomes possible to perform downsizing and high performance.

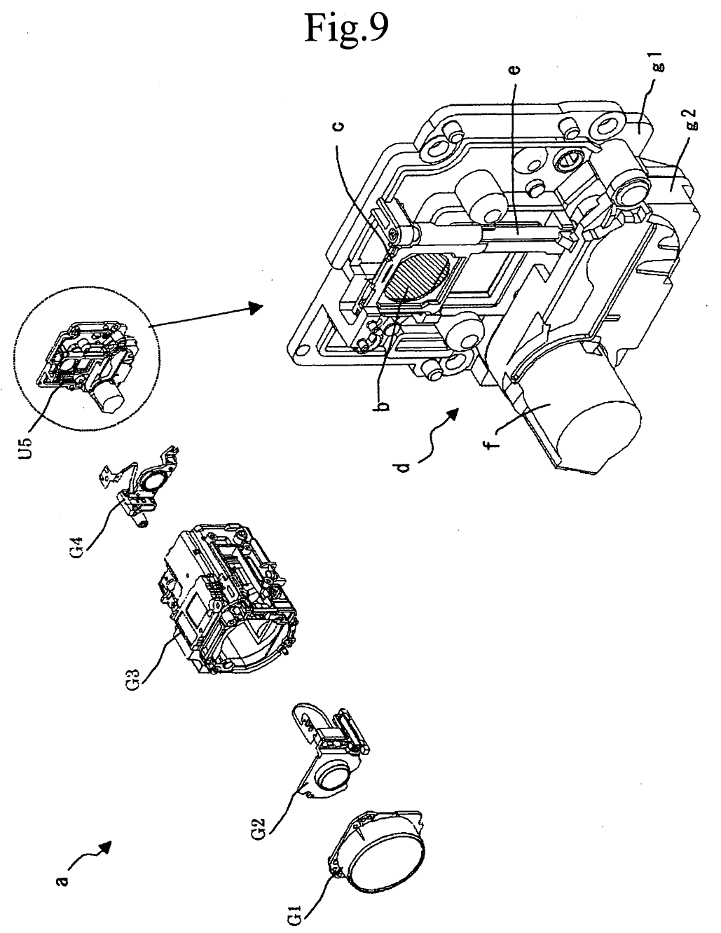

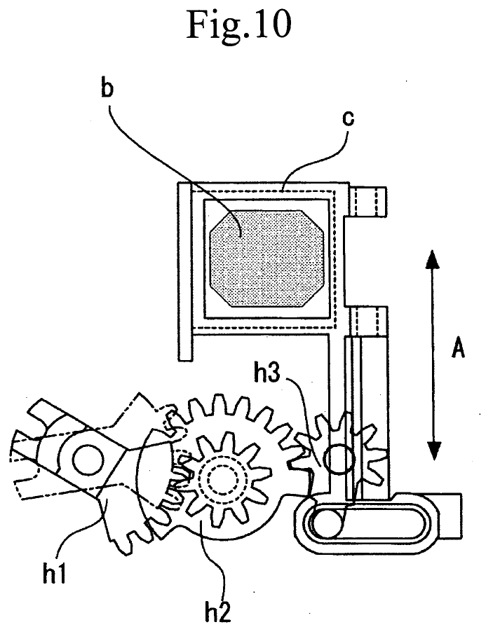

According to the present invention, it becomes possible to reduce the total number of parts compared to a conventional configuration. For, example, in the conventional configuration as shown in FIG. 9 and FIG. 10, 8 parts including the actuator f, the gears h1 to h3, the gear cover g2, the guide axis e, the support frame c and the IR cut filter b are required, but, in contrast, in the night shot mechanism NS to which the present invention is applied, only 6 parts including the actuator 13, the arm 14, the plate member 17, the base member 18, the cover 19, and the IR cut filter 12 are necessary as shown in FIG. 4 and FIG. 5, that is, the number of parts required is able to be reduced by 2 as a total.

Because the thickness of the IR cut filter 12 is smaller than that of the conventional glass filter, the change of image location by the insertion/removal of the filter becomes small. Thereby, it is not necessary to use any focal point adjusting member, and is able to make relatively small in the deterioration of the optical performance.

This application claims priority from Japanese Priority Document No. 2003-325664, filed on Sep. 18, 2003 with the Japanese Patent Office, which document is hereby incorporated by reference.

1. An image taking apparatus comprising:
a mechanism for inserting/removing a filter on/from an optical axis of an image taking optical system of the image taking apparatus, wherein;
said filter is made of one of film material and sheet material.

2. The image taking apparatus as cited in claim 1, wherein;
said filter is an IR cut filter; and
said mechanism changes an image taking mode of the image taking apparatus between a first mode where the IR cut filter is inserted on the optical axis of the image taking optical system and a second mode where the IR cut filter is removed from the optical axis of the image taking optical system.

3. The image taking apparatus as cited in claim 2, wherein;
said mechanism for changing the image taking mode between the first mode and the second mode directly drives the IR cut filter.

4. The image taking apparatus as cited in claim 2, wherein;
said IR cut filter is formed by applying an IR cut coating on said one of film material and sheet material.

5. The image taking apparatus as cited in claim 1, wherein;
said image taking optical system has an inner focus type configuration.
